(19) United States
(12) Patent Application Publication
(10) Pub. No.: US 2004/0142479 A1
(43) Pub. Date: Jul. 22, 2004

(54) Reaction plate with slidable cover and method to use the same

(76) Inventors: Robert Moerman, Hn Den Haag (NL); Willem Karel Gigs Van Dedem, Vx Oss (NL)

Correspondence Address: Martin J Hirsch, Marshall Gerstein & Borun, 6300 Sears Tower, 233 South Wacker Drive, Chicago, IL, 60606-6357, US

(21) Appl. No.: 10/467,563

(22) PCT Filed: Feb. 14, 2002
(86) PCT No.: PCT/NL02/00095

(30) Foreign Application Priority Data
Feb. 15, 2001 (NL) 1017374

(51) Int. Cl. B01J 19/00

(52) U.S. Cl. 436/34; 422/130

(57) ABSTRACT

The invention relates to device for carrying out a reaction, which device comprises a substrate (2) provided with a well (4) for carrying out the reaction, and a cover means (3). According to the invention the cover means (3) is provided with an aperture (5), which in a first position does not overlap the well (4), while in a second position overlapping the well at least partly. Such a device can be filled in a simple manner and evaporation of liquid from the well (4) is to a large extent prevented. The invention also relates to a method for carrying out a reaction in a device according to the invention.

The present invention relates to a device for carrying out a reaction which device comprises

a substrate provided with a well; and

a cover means for covering the substrate and in particular the well.

Such a device is generally known, for example, in the form of ELISA plates. The ELISA plates may be covered with a hard plastic cap or with adhesive film. The problem of the liquid in the well evaporating increases especially in devices in which reactions are carried out in a very small reaction volume, while the application of the cover means becomes more difficult. This applies in particular to substrates that have very small wells, e.g. wells having a volume of <10 nl.

It is an object of the present invention to provide a device comprising a substrate and a cover means, wherein the cover means permits the well to be filled and subsequently covered quickly and satisfactorily.

To this end the device according to the preamble is characterised in that the substrate has an upper side and the cover means a lower side, the cover means and the substrate being slidable in relation to one another in the plane of the upper side of the substrate, and that the substrate is provided with an aperture, which in a first position does not overlap the well, while in a second position overlapping the well at least partly.

Such a device allows the well to be filled by means of surface tensional forces at any desired moment.

In practice, the device will comprise several wells, which wells are preferably arrayed in the form of a regular pattern. Further, in general at least either the lower side of the cover means or the upper side of the substrate will be flat.

The cover means is preferably provided with several apertures, and preferably there is an equal number of wells and apertures and the apertures are substantially arranged in the same pattern as the openings.

This allows the wells to be filled simultaneously without any liquid being transferred from one well to the other, which could result in false positive reactions.

The diameter of the apertures is preferably at least at the lower side of the cover means smaller than the distance between two adjacent wells.

This allows the cover means to be moved over a short distance to the first position.

Preferably at least one of the surfaces chosen from the lower side of the cover means and the upper side of the substrate is hydrophilic.

The hydrophilic nature enhances the rate of transport of liquid between the cover means and the substrate. It also increases the likelihood of the well being filled successfully.

According to a preferred embodiment, the cover means is provided with a feed aperture for feeding a liquid, which feed aperture exits above the upper side of the substrate.

Such a feed aperture makes it possible to feed liquid via the upper side of the cover means instead of via the gap between the substrate and the cover means. This not only makes it simpler to supply the liquid, but will in practice also mean that the liquid can be supplied in closer proximity to the wells, which means that filling can be effected more quickly. The feed aperture will not be located above a well to be filled.

The well is preferably provided with a reagent.

The reagent may be a receptor or ligand, such substances being understood to mean a substance that specifically, and preferably with a high affinity, binds to a substance to be detected (or mutatis mutandis is bound thereby). The reagent may also be a substrate for an (enzyme) reaction.

Advantageously at least either the substrate or the covering means is optically transparent, and more advantageously they both are.

In this way it is possible to carry out measurements on a substrate very simply and quickly, allowing parallel measurements in the case of an array of wells.

The invention also relates to a method for carrying out a reaction with the aid of a device according to the invention.

To this end the method according to the invention is characterised in that a liquid is fed to the device and due to capillary action the space between the substrate and the cover means is filled with liquid, in that in order to fill the well with liquid, the substrate and the cover means are in the second position and air is discharged via the aperture, and in that after the well has been filled, the cover means and the substrate are slid in relation to one another in order to move the cover means and the substrate to the first position.

By adhering to a particular distance between the cover means and the substrate, which distance may be simply determined by trial, it is possible to ensure that in the first instance the well is not being filled, while due to capillary action the space between the upper side of the substrate and the cover means is being filled. By allowing the well and the aperture to overlap, the air that first helped to prevent the well being filled may be discharged allowing the well to be filled.

This method is especially favourable because the liquid comes from the immediate surroundings of the well. The currents are such that in the case of several wells, substantially no contamination can occur between the different wells. The necessary distance depends on the hydrophilic nature of the surfaces of the substrate and the cover means, as well as that of the liquid. If the well is already being filled during the feeding of the liquid to the device, the distance between the substrate and the cover means is too great. If there is insufficient liquid for filling the well, the distance between the substrate and the cover means is too small.

Preferably the liquid is fed to the device via the feed aperture. This makes simple filling of the wells possible.

Once back in a first position, the cover means is pressed to the substrate preferably with a force of 1-2 kg/cm² in order to further limit evaporation via an aperture.

The invention will now be elucidated with the aid of the following exemplary embodiment and with reference to the drawing in which

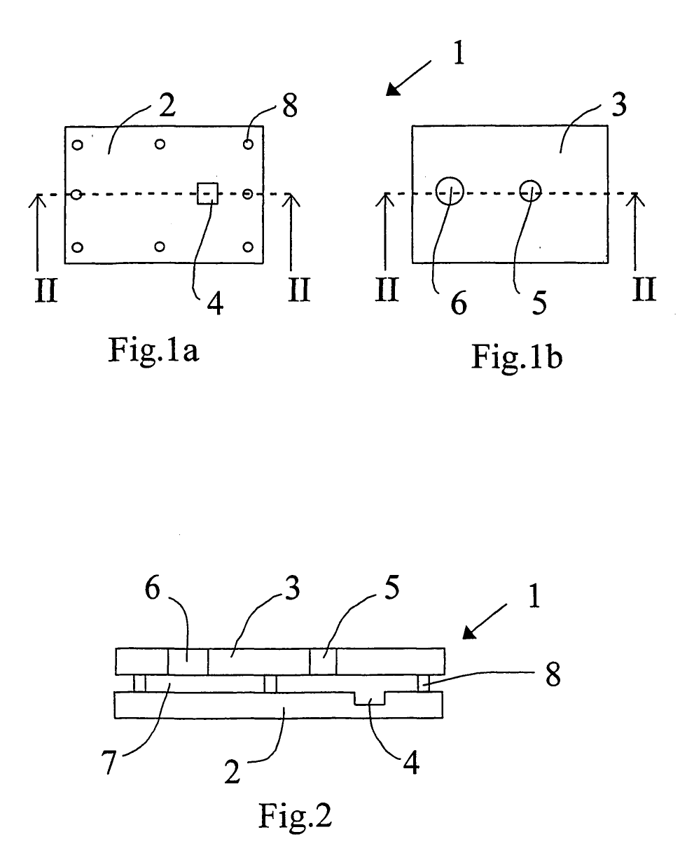

FIG. 1 a and b, respectively, show a top view of the substrate of a device according to the invention, as well as a bottom view of the cover means for the substrate;

FIG. 2 shows a cross section along the line II-II of the device represented in FIG. 1;

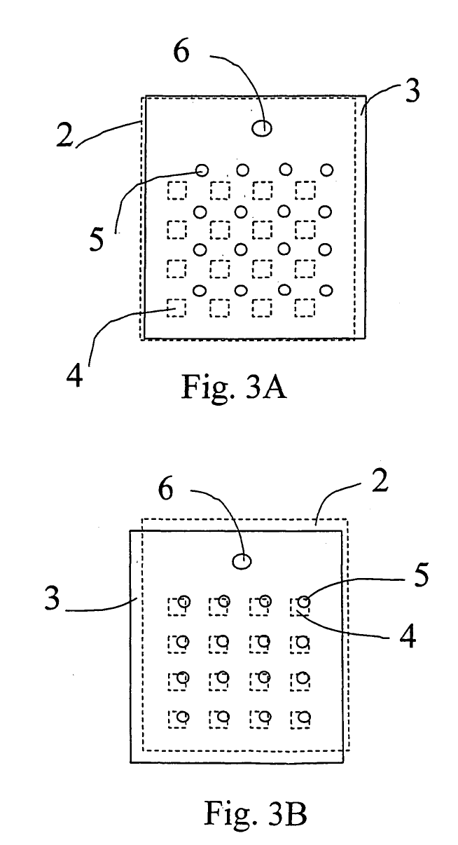

FIG. 3a shows a top view of a device according to the invention with the cover means and the substrate in a first position in relation to one another; and

FIG. 3b shows the same top view of a device according to the invention with the cover means and the substrate in a second position in relation to one another.

FIG. 1 shows a device 1 according to the invention, which device comprises a substrate 2 and a cover means 3.

The substrate 2 is a silicon substrate that by means of well-known techniques has been provided with a silicon nitride surface. The substrate 2 is provided with a matrix of wells 4 (one of which is shown) for the reproducible, and in particular with reproducible speed, filling of wells 4. The substrate 2 is at its upper side provided with projecting elements 8. At its lower side, the cover means 3 is completely flat so that once the cover means has been placed on the substrate 2, it is slidable equidistant to the surface of the substrate.

In FIG. 2, in which the cover means formed by a polymethyl methacrylate cover slip (thickness 0.5 mm) is placed on the substrate 2, an aperture 5 can be seen, which does not overlap with a well 4. In the first position, shown here, the liquid can be fed to the device via a feed aperture 6, so that the gap 7 between the surface of the substrate 2 and the lower side of the cover means 3 is filled with liquid. In FIG. 3a this first position is shown for a substrate 2 in a top view (represented by dotted lines) comprising a plurality of wells 4. The cover means 3 (drawn as continuous lines) comprises apertures 5, which in this first position do not overlap the wells 4. Due to the interaction of cohesive and adhesive forces (which interaction depends on the hydrophilicity of the liquid and the surface of the substrate 2 and the cover means 3) the gap 7 is filled with liquid but the wells 4 are not. These are/remain filled with air. By moving the cover means 3 and the substrate 2 in relation to each other to a second position in which the aperture 5 overlaps well 4 at least partly (as shown for the substrate of FIG. 3a, in FIG. 3b), the air can escape from the well 4 and liquid is able to flow into well 4. If the centres of the aperture 5 and the well 4 coincide, the liquid is supplied from radial direction, guaranteeing absolutely that any reactant present in the well 4 will not flow into another well 4.

The projecting elements 8 on the surface of the substrate 2 and the cover means 3 may interact in such a way that the cover means 3 is provided with recesses so that even before there is an overlap between the aperture 5 and a well 4, the projecting elements 8 will fall into the recesses (not shown) of the cover means 3, as a result of which the substrate 2 and the cover means 3 are kept apart by liquid that is present in the gap 7. When the second position, in which there is an overlap between the aperture and the well 4 is reached, the width of the gap 7 can decrease to allow the well 4 to be supplied with liquid.

After the wells 4 have been filled, the cover means may be positioned such that there is no longer any overlap between the well 4 and the aperture 5, the cover means 3 may be pressed against the substrate 2 with a sufficient force to ensure that any loss of liquid from the well 4 will be virtually negligible.

The cover means 3 may be made, for example, of Perspex (PMMA) or of glass. This provides an optically transparent cover means that makes it possible to carry out optical measurements. Optionally, the substrate 2 may (also) be made of such a material and may also be optically transparent. Around the wells 4 the substrate 2 may be provided with rubber to provide a seal.

1. A device for carrying out a reaction which device comprises
a substrate provided with a well; and
a cover means for covering the substrate and in particular the well, characterized in that the substrate has an upper side and the cover means a lower side, the cover means and the substrate being slidable in relation to one another in the plane of the upper side of the substrate, and that the substrate is provided with an aperture, which in a first position does not overlap the well, while in a second position overlapping the well at least partly.

2. A device according to claim 1, characterized in that the device comprises several wells.

3. A device according to claim 1, characterized in that the wells are arrayed in the form of a regular pattern.

4. A device according to one of the claims 1 to 3, characterized in that the cover means is provided with several apertures.

5. A device according to claim 4, characterized in that there is an equal number of wells and apertures, and the apertures are substantially arranged in the same pattern as the openings.

6. A device according to one of the preceding claims, characterized in that the diameter of the apertures is at least at the lower side of the cover means smaller than the distance between two adjacent wells.

7. A device according to one of the preceding claims, characterized in that at least one of the surfaces chosen from the lower side of the cover means and the upper side of the substrate is hydrophilic.

8. A device according to one of the preceding claims, characterized in that the cover means is provided with a feed aperture for feeding a liquid, which feed aperture exits above the upper side of the substrate.

9. A device according to one of the preceding claims, characterized in that the well is provided with a reagent.

10. A device according to one of the preceding claims, characterized in that at least either the substrate or the covering means is optically transparent.

11. A method for carrying out a reaction in a device according to one of the claims 1 to 10, characterized in that a liquid is fed to the device and due to capillary action the space between the substrate and the cover means is filled with liquid, in that in order to fill the well with liquid, the substrate and the cover means are in the second position and air is discharged via the aperture, and in that after the well has been filled, the cover means and the substrate are slid in relation to one another in order to move the cover means and the substrate to the first position.

12. A method according to claim 11, characterized in that in a first position, in which the through-flow opening does not overlap the well, a liquid is fed to the device, wherein due to capillary action the space between the substrate and the cover means is not filled with liquid, the cover means and the substrate are slid in relation to one another to the second position in order to fill the well with liquid, and in that after the well has been filled the substrate and the cover means are moved in relation to one another in order to return the cover means and the substrate to the first position.

13. A method according to claim 11 or 12, characterized in that the liquid is fed to the device via the through-flow opening.

14. A method according to one of the claims 11 to 13, characterized in that once back in a first position, the cover means is pressed to the substrate with a force of 1-2 kg/cm².
